(19) United States
(12) Patent Application Publication
(10) Pub. No.: US 2008/0041231 A1
(43) Pub. Date: Feb. 21, 2008

(54) Method and device for brewing beverages

(75) Inventors: Christopher Randall Beharry, Cincinnati, OH (US); James Earl Trout, West Chester, OH (US); Stephen Jerome Westerkamp, Milford, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/505,674

(22) Filed: Aug. 17, 2006

(51) Int. Cl. A47J 31/00

(52) U.S. Cl. 99/279

(57) ABSTRACT

A method and device for brewing beverages is disclosed. The design incorporates a heater incorporating an advantageous combination of heating reservoir size and heating element power. The design also incorporates a purging process to dry a coffee pod after use.

### FIELD OF THE INVENTION

The present invention concerns a method and device for brewing beverages. It has particular utility in brewing plain coffee, espresso, cappuccino, and similar beverages, but may be used to brew any sort of beverage.

### BACKGROUND OF THE INVENTION

Brewed beverages prepared by mixing, steeping, soaking, or boiling a brewing material in water or other brewing liquid have been known for quite some time. For example, coffee may be made by passing hot water through ground coffee beans, and tea may be made by seeping crushed tea leaves in hot water. Similarly, brewing materials may be a liquid, such as liquid creamer or chocolate. More generally, brewing material may include an extractable solid, liquid, powder, concentrate or other material used in a brewing operation. As used herein, the term “coffee” includes not only plain coffee, but also coffee in all its other forms such as for example espresso, cappuccino, mocha, decaffeinated coffee, and the like. The art of preparing such brewed beverages has improved over time. Nonetheless, known coffee brewers which brew ground coffee beans under pressure to make coffee suffer from several drawbacks.

For example, known heaters used in such devices have included relatively large reservoirs for holding a brewing liquid as it is being heated, with a maximum capacity of about 300 to 350 ml of brewing liquid. Because these known reservoirs hold a relatively large amount of water, it takes a long time to heat the water up at the beginning of the brew process. This drawback is particularly acute when a sufficient amount of time has passed since the previous brew that the temperature of the water in the reservoir has decreased all the way to room temperature, thus requiring a “cold start.” In some known machines this leads to a long pre-brew heating process which can last 90 seconds or more, before coffee can actually be brewed. This causes a long wait for the user to get his or her coffee. These known units further incorporate a coiled heating element which is disposed at one end of the heater, remote from the other end.

Known brewing devices have also heated a brewing liquid by disposing heating elements on the outside of delivery conduits carrying a flow of brewing liquid. Thus, in these devices, the brewing liquid is heated as it flows from a storage reservoir to the brewing chamber. The portion of the delivery conduits where the brewing liquid is heated in these devices may have a maximum storage capacity of only about 10 to 15 ml of brewing liquid. Because of those small storage capacities, these heaters have a relatively fast heat up time.

However, heating such relatively small amounts of water at one time increases the difficulty of controlling the temperature of the brewing liquid during a brewing operation. Brewing liquid temperature is controlled by feedback from a temperature sensor, but it takes some amount of time for the sensor to react to the temperature of the brewing liquid and provide a signal to a system controller indicative of brewing liquid temperature. By the time that signal is transmitted, the brewing liquid temperature has changed again—which happens quickly because of the small volumes involved—and the controller acts on old information. This temperature sensor measurement time lag makes reaching an optimal steady state brewing liquid temperature difficult in small volume capacity heating reservoirs.

Cleaning out spent brewing material from the brewing chamber after a brewing operation is complete can often be a messy process. Typically the spent brewing material is left as an excessively wet mass of material contained in a flimsy piece of filter material or filter pod, which can be difficult to pry out of a brew basket or other container forming the brewing chamber.

Some current brewing systems generate steam near the end of a brewing operation as part of a purging process. These known systems, however, are very inefficient in that they have little or no control over the amount of the steam generated. They attempt to control the amount of steam generated by metering a supply of water to a heater to be boiled. However, these known devices use small heating chambers for the boiling operation. This allows an appreciable amount of unvaporized water to be carried along with the steam through the system, which is disadvantageous. Also, the amount of steam generated is variable from brew to brew, leading to unknown amounts of steam and brewed beverage being created.

Known prior brewing devices principally rely on varying the power of a heating element to control the temperature of the brewing liquid. Such systems result in a time delay between detecting the need for a temperature change and effecting a temperature change. That time delay is due to the slow response time between changing the voltage of the heating element, and that changed voltage actually resulting in a change of outputted power by the heating element. The heating element will have some resistance to changes in power, which it takes time to overcome.

### SUMMARY OF THE INVENTION

A heater which is particularly useful in coffee brewers and other brewing devices is disclosed. The heater comprises a body forming a heating reservoir having an inlet for a brewing liquid to enter the heating reservoir and an outlet for the brewing liquid to exit the heating reservoir. The heating reservoir has a volume capacity for storing brewing liquid. One or more heating elements are disposed in or near the body for heating the brewing liquid disposed in the heating reservoir, and a source of voltage controls a power of the one or more heating elements. The volume capacity of the heating reservoir and the power of the one or more heating elements are selected so as to have a watt density of no less than about 6 watts per milliliter and no more than about 30 watts per milliliter. The heater design permits a fast heat up time, while at the same time allowing good control of the brewing liquid temperature leaving the heater. It also can lead to fast overall brewing times, on the order of 90 seconds to brew a seven ounce cup of black coffee from a cold start.

Also disclosed is a brewing device. The brewing device comprises a pump having a pump inlet and a pump outlet, with the pump inlet being fluidically connected to a reservoir of brewing liquid to pump the brewing liquid at a flow rate. A heater comprises a heater body and a heating element. The heater body forms a heating reservoir and has a heater inlet and a heater outlet. The heater inlet is fluidically connected to the pump outlet. The heating element is disposed in or near the heating reservoir for heating a brewing liquid in the heating reservoir. The heating reservoir having a volume capacity. A temperature sensor for measuring the temperature of the brewing liquid has a measurement lag time. The flow rate, the heating reservoir volume capacity, and the temperature sensor measurement lag time are chosen so that a residence-to-lag time ratio is no less than about 2 and no more than about 10. A brewing chamber holds a supply of coffee to be brewed by the brewing liquid, with the brewing chamber having a chamber inlet and a chamber outlet. The chamber inlet is fluidically connected to the heater outlet by a liquid flow path. A dispensing outlet is fluidically connected to the chamber outlet. The heater design permits a fast heat up time, while at the same time allowing good control of the brewing liquid temperature leaving the heater.

Also disclosed is a brewing and purging process in a brewing device, comprising placing a brewing material in a brewing chamber of the brewing device, operating a heating element disposed in or near a heating reservoir to heat a supply of brewing liquid, which includes at least some amount of water, operating a pump to pressurize the brewing liquid, and using the pressurization to pass the heated supply of brewing liquid through the brewing material to perform a brewing operation, and after the brewing operation is complete, deactivating the pump and setting a power of the heating element so that a portion of water in the heater becomes steam, and generating the steam for a pre-determined amount of steam time, and passing the steam through the brewing material in the brewing chamber. The purging process at least partially dries spent brewing material in the brewing chamber, thus making it easier to clean out of the brewing chamber. The purging process also permits a high degree of control and repeatability of the steam generating process. The purging process may advantageously be used with the heater design, because the smaller storage capacity of the heater makes generating steam easier and more efficient.

Also disclosed is a method of brewing a brewing material in a brewing device, comprising placing the brewing material in a brewing chamber of the coffee brewing device, operating a heating element disposed in or near a heating reservoir to heat a supply of brewing liquid, operating a pump to pressurize the brewing liquid, and using the pressurization to pass the heated supply of brewing liquid through the brewing material to perform a brewing operation, and adjusting a flow rate of the brewing liquid during the brewing operation to control a temperature of the brewing liquid. This method permits a fast time response between detecting the need for a temperature change and effecting a temperature change, thus improving the overall brewing process.

These and other advantages of the present invention will become more apparent from a detailed description of the invention.

### BRIEF DESCRIPTION OF THE DRAWINGS

In the accompanying drawings, which are incorporated in and constitute a part of this specification, embodiments of a brewing method and device are illustrated. These drawings, together with the general description of the brewing method and device given above and the detailed description given below, serve to example the principles of this invention.

FIG. 1 is a top perspective view of one embodiment of a brewing device including a closure mechanism, a reservoir, a brewing unit and a drip tray.

FIG. 2 shows several different elements of a representative brewing system.

FIG. 3 is a perspective view of a manifold including a temperature sensor, a pressure relief valve and a vacuum vent valve.

FIG. 4 is a side view of one embodiment of a heater for use in a brewing device.

FIG. 5 is another side view of the heater shown in FIG. 4.

FIG. 6 is a cross-sectional view of the heater shown in FIG. 4, taken along the line 6-6 in FIG. 4.

FIG. 7 is a cross-sectional view of the heater shown in FIG. 4, taken along the line 7-7 in FIG. 5.

FIG. 8 is a graph illustrating a watt density property of heating systems used in brewing devices.

FIG. 9, like FIG. 6, is a cross-sectional view of the heater shown in FIG. 4 taken along the line 6-6 in FIG. 4, but shows a supply of brewing liquid disposed within the heater.

FIG. 10 is a schematic representation of a brewing device including a controller which may perform a temperature control process.

FIG. 11A is a flowchart showing a temperature control process.

FIG. 11B is a flowchart showing a temperature control process.

FIG. 12 is a flowchart showing a purging process.

### DETAILED DESCRIPTION OF PREFERRED EMBODIMENTS

Referring now to the drawings in which like numerals designate like parts throughout the various views, preferred embodiments of a brewing method and device are shown.

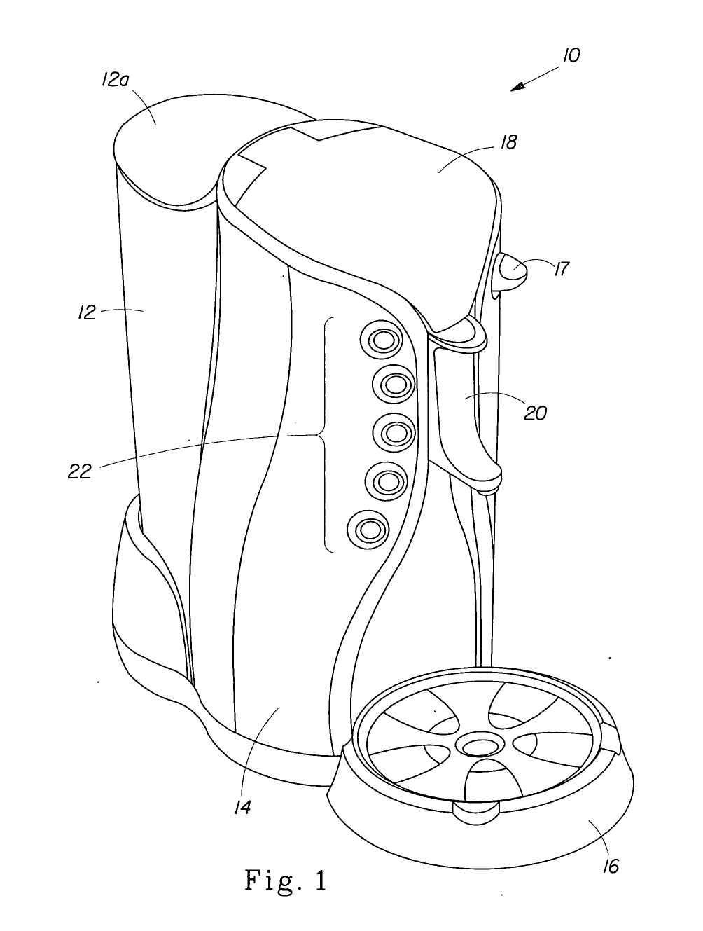

FIG. 1 shows one embodiment 10 of a brewing device. The brewing device 10 includes a storage reservoir 12 for holding a supply of brewing liquid such as water, a brewing unit 14 in which the brewed beverage is prepared, and a drip tray 16. The storage reservoir 12 is shown as a separate component from the brewing unit 14, but may of course be alternatively disposed within the brewing unit 14. The brewing unit 14 may include a release handle 17 for releasing a closure mechanism 18, a dispensing outlet including a spout 20 for dispensing a brewed beverage, and one or more operational control switches 22 to control aspects of the brewing operation. Such aspects may include for example duration of brewing and amount of brewed beverage to dispense. The storage reservoir 12 has a removable lid 12a to facilitate refilling the storage reservoir 12 with a brewing liquid. In FIG. 1, the closure mechanism 18 is shown in a closed position.

In operation, the brewing device 10 uses a supply of brewing liquid from the storage reservoir 12 in a brewing operation within the brewing unit 14 to produce a brewed beverage such as coffee. The brewing device 10 then dispenses the brewed beverage out of the spout 20 and into a cup or other receptacle disposed on or over the drip tray 16. To accomplish this, various fluid conduits are present in the brewing device 10 to form a brewing liquid supply line, as will be understood by one of ordinary skill in the art. The drip tray 16 catches and holds brewed beverage which may be accidentally dispensed through the spout 20 without a cup or receptacle disposed underneath it, or which may spill from the cup or receptacle.

Typically the brewing material is disposed in a brewing chamber (not shown) within the brewing unit 14. Usually the brewing material is placed in the brewing chamber on top of one or more pieces of filter material, or entirely disposed within a surrounding filter material pod which is inserted as a unit into the brewing chamber. Whatever its form, the filter material operates to contain the brewing material within the filter chamber throughout the brewing process, while permitting brewed liquid to pass through the filter material and out the spout 20. Thus the brewing material is prevented from entering the user's cup or clogging up the system downstream of the brewing chamber. When pods are used, they may advantageously contain more than one brewing material. For example, a first chamber of the pod can contain ground up coffee and a second chamber can contain milk, thus creating a latte as a brewed beverage. The term “milk” as used herein includes all forms of milk and milk substitutes, in whatever form, such as for example whole milk, skim milk, raw milk, pasteurized milk, condensed milk, dry milk, evaporated milk, powdered milk, cream, half-and-half, buttermilk, and the like. Sugar or other brewing materials may also advantageously be placed in a pod. The brewing chamber may be formed by a brew basket which is removable from the brewing unit 14 to allow cleaning and maintenance operations to be performed.

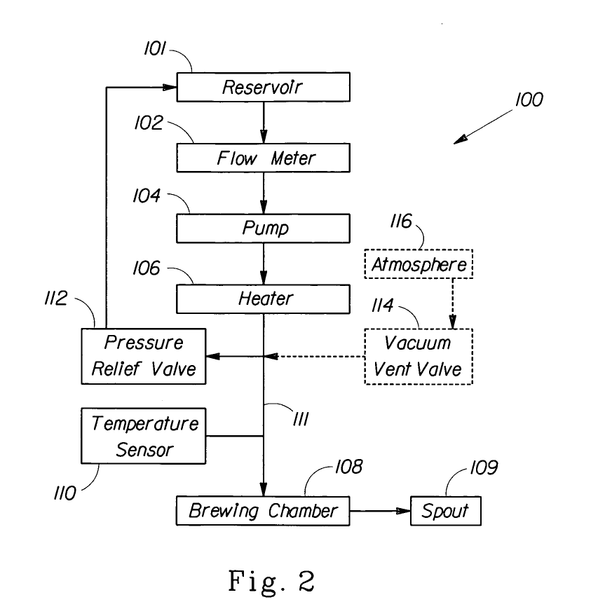

A brewing system 100 may incorporate several different elements, and FIG. 2 shows a representative set of such elements. The solid boxes and arrows in FIG. 2 represent components which are meant to carry or process brewing fluid. The solid arrows thus represent flexible tubes, or passageways defined by one or more rigid structures, or a combination of both tubing and rigidly formed passageways, which are capable of holding liquid. The dotted boxes and arrows in FIG. 2 represent components which are meant to carry or process air.

The brewing liquid may be stored in a storage reservoir 101, such as the storage reservoir 12 of the brewing device 10 shown in FIG. 1, before the brewing operation begins. By action of gravity or perhaps a pump 104, the brewing liquid passes from the storage reservoir 101 through a flow meter 102 to reach the pump 104. The flow meter 102 measures the flow rate of the brewing liquid. That flow rate may be used, for example, by an electronic controller within the brewing device 10 to monitor and control the brewing process. For example, it can be used to determine whether the storage reservoir 101 is out of brewing liquid, for in that event the flow rate would be zero. Such a flow meter may be obtained AWECO Appliance Systems in Neukirch, Germany.

The pump 104 pumps the brewing liquid under pressure to and through a heater 106 to reach a brewing chamber 108, such as the brewing chamber of the brewing device 10. A representative pump for this application is a vibration pump which may be obtained from ULKA Srl in Pavia, Italy as Model ER Type EP8R.

Once the brewing liquid is heated by the heater 106 to a desired temperature, it travels to the brewing chamber 108 where it is mixed, steeped, soaked, boiled or otherwise brewed with a brewing material in order to make a brewed beverage. The brewed beverage is then dispensed from the brewing device, typically under the force of gravity or pressure supplied by the pump 104. The brewed beverage may advantageously be dispensed from a spout 109, such as the spout 20 of the brewing device 10, to fall into a cup, pot or other receptacle for consumption.

The representative embodiment of FIG. 2 has several elements disposed within or fluidically connected to the fluid flow path 111 between the heater 106 and the brewing chamber 108. A temperature sensor 110 such as a thermister 500 may measure the temperature of the brewing liquid as it passes from the heater 106 to the brewing chamber 108. A thermister 500 is an electrical resister made of a material having an electrical resistance which varies in a known and well-defined manner with temperature. Those temperature measurements may be used by an electronic controller within the brewing device 10 to monitor and control the brewing process. For example, the measurements can be used to determine whether the heater 106 is over- or under-heating the brewing liquid, and consequently whether the power of a heating element in the heater 106 should be increased or decreased, or if the brewing liquid flow rate should be changed.

The representative embodiment of FIG. 2 further includes a pressure relief valve 112 and a vacuum vent valve 114 fluidically connected to the fluid flow path 111 between the heater 106 and the brewing chamber 108. The pressure relief valve 112 is a check valve which ensures that the pressure within the brewing system 100 downstream of the pump 104 does not exceed a predetermined maximum value for safety or good brewing purposes, such as 20 psi. Thus the pressure relief valve 112 is normally in a closed position, not permitting liquid or air to pass through it. However, the pressure relief valve 112 opens if and when the pressure within the fluid flow path 111 exceeds the predetermined maximum value. In the event the pressure relief valve 112 does open, the brewing liquid is permitted thereby to pass out of the fluid flow path 111, preferably back to the storage reservoir 101 where it can be collected. Although not shown in FIG. 2, the brewing liquid escaping through the pressure relief valve 112 may alternatively be led out to the atmosphere 116, or to the drip tray 16, or anywhere else to relieve the fluid flow path 111 of pressure built up downstream of the pump 104.

The vacuum vent valve 114 connects the surrounding atmosphere 116 to the brewing system 100. The vacuum vent valve 114 is a check valve which opens to let air into the brewing system 100 if the pressure within the system drops far enough below atmospheric pressure by some minimum pressure differential, for example 0.2 psi. This typically occurs near or at the end of a brewing cycle, when the pump 104 stops applying pressure and steam left over in the system 100 begins to condense. This decreases the pressure within the system 100. Opening of the vacuum vent valve 114 prevents any liquid remaining in the brewing chamber from being drawn back into the line 111 by vacuum pressure.

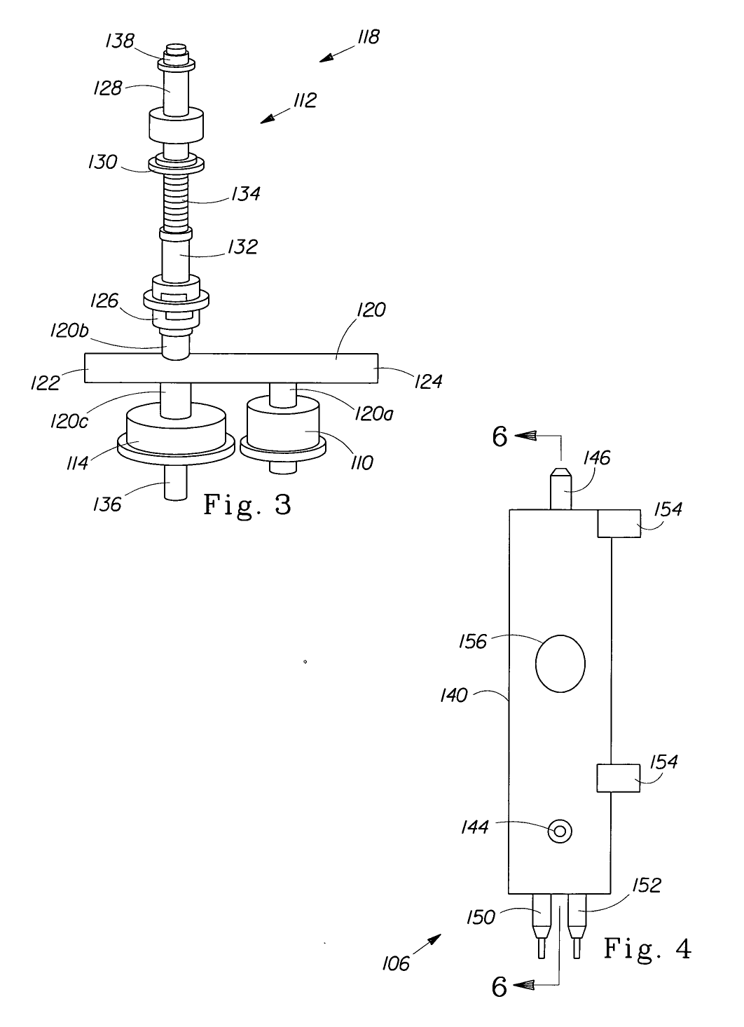

FIG. 3 shows a manifold 118 which advantageously incorporates, in a single modular component having a rigid structure, a temperature sensor 110, a pressure relief valve 112, and a vacuum vent valve 114. Thus a rigid central tube 120 has an inlet end 122 and an outlet end 124 opposite the inlet end 122. A first flexible tube may be connected to the inlet end 122 to bring heated brewing beverage from a heater 106, and a second flexible tube may be connected to the outlet end 124 to carry heated brewing beverage to the brewing chamber 108. The ends 122, 124 may be flanged as shown in FIG. 3 to facilitate a sealed connection with the flexible tubes.

Rigid tube connectors 120a, 120b and 120c respectively connect the temperature sensor 110, pressure relief valve 112, and vacuum vent valve 114 to the central tube 120. Electrical connectors (not shown) may extend away from the temperature sensor 110 to an electronic controller. A flexible tube or other conduit may be connected to an outlet end 136 of the vacuum vent valve 114 to lead to the atmosphere 116 or other air supply.

In the embodiment of FIG. 3, the pressure relief valve 112 includes a lower valve body 126 attached to an upper valve body 128 to form a valve cavity sealed with an O-ring 130. The O-ring 130 may be made of a suitable sealing material such as rubber or silicone rubber. A valve member 132 is disposed within the valve chamber, and is normally urged by a spring 134 to a closed position preventing brewing liquid from leaving the tube 120 through the valve 112. The valve member 132 may advantageously be made of silicone rubber. A flexible tube or other conduit may be connected to an outlet end 138 of the pressure relief valve 112, to carry expelled liquids back to the reservoir 101 or some other place for expelling liquid.

The manifold 118 may, of course, be configured in several ways which are different from the representative embodiment shown in FIG. 3. For example, if it would be desirable for the manifold 118 to take up less space, the manifold 118 could incorporate a 90° bend in the central tube 120 at the point where it intersects with the tube connector 120a. It will also be appreciated that one or more of the temperature sensor 110, pressure relief valve 112, and vacuum vent valve 114 may not be part of a manifold 118. For example, the manifold 118 may include only the pressure relief valve 112 and vacuum vent valve 114, with the temperature sensor 110 disposed elsewhere in the brewing system 100. Moreover, the order and spatial configuration of the various components in the manifold 118 as shown in FIG. 3 does not have any special significance. Thus the components may alternatively be disposed all on one side of the central tube 120, in a single row. Or, the temperature sensor 110 may be disposed upstream of the two valves 112, 114. It will thus be appreciated that various options are available in forming a manifold 118 for use in a particular brewing device. Use of a manifold 118 advantageously eliminates several fluidic connection points between flexible tubes and rigid structure (such as the connection at the ends 122, 124), thus reducing the chance of developing a leak. For example, the junction between the valves 112, 114 and the temperature sensor 110 does not have any connection points.

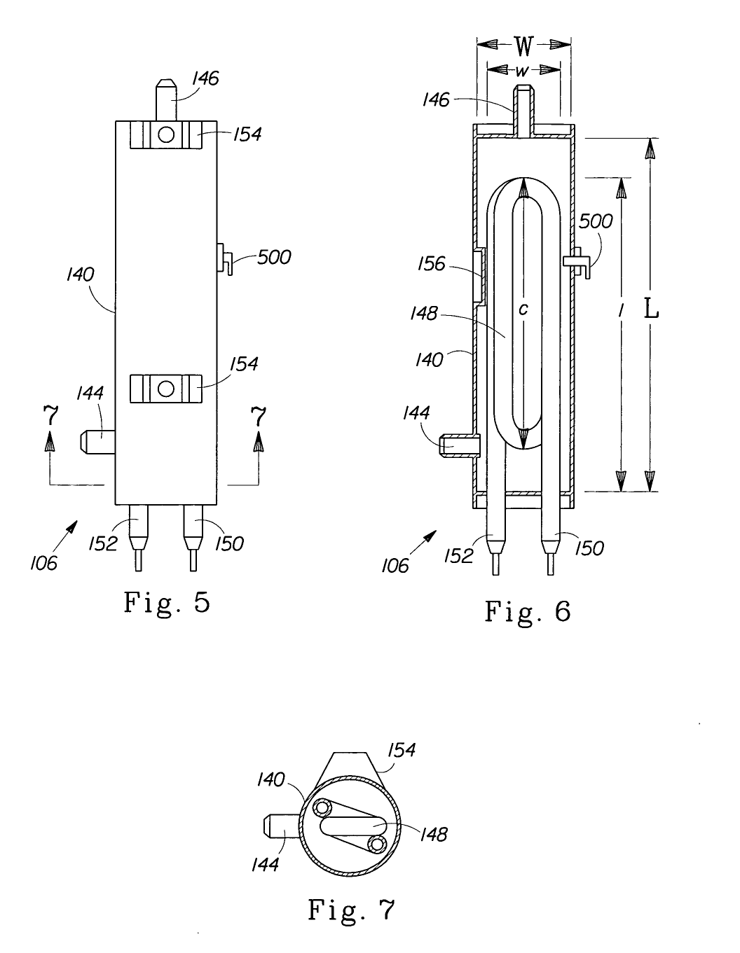

FIGS. 4-7 show one embodiment of a heater 106. The heater body 140 defines a heating reservoir 142 including an inlet 144 to the heating reservoir 142 and an outlet 146 from the heating reservoir 142. The illustrated body 140 is of an elongated, generally cylindrical or oval shape, but any shape is possible. Flexible tubing may carry brewing liquid under pressure from the pump 104 to the inlet 144. Other flexible tubing may carry brewing liquid away from the heater outlet 146 to be taken to a brewing chamber. The inlet 144 and outlet 146 may be disposed at or near opposite ends of the heater 106, as shown for example in FIGS. 4-7. Brackets 154 may be used to mount the heater 106 within a brewing unit 14. The heater 106 may have a storage capacity of about 100 ml of brewing liquid.

The heating reservoir 142 houses a coiled cal rod heating element 148. Contacts 150, 152 extend outside of the reservoir 142 to be electrically connected to a voltage source, perhaps controlled by an electronic controller. Although the heating element 148 is shown disposed inside the heater body 140, it may alternatively be disposed on or near the exterior of the heater body 140. Varying the applied voltage to the heating element 148 changes the power output of the heating element 148, and therefore changes the temperature of the heating element 148. Heat generated by the heating element 148 is transferred to the brewing liquid to heat it up. Heating element power is discussed further below.

The heating reservoir 142 has a length dimension L along a first axis, and a width dimension W along a second axis which is perpendicular to the first axis, such as shown for example in FIG. 6. The heating element 148 has a maximum length dimension l which extends along the first axis, as shown for example in FIG. 6. The maximum length l is preferably at least one-half of the length L, more preferably is at least three-quarters of the length L, and most preferably is substantially the same as the length L. Similarly, the heating element 148 has a maximum width dimension w which extends along the second axis, as shown for example in FIG. 6. The maximum width w is preferably at least one-half of the width W, more preferably is at least three-quarters of the width W, and most preferably is substantially the same as the width W. The heating element 148 additionally has a maximum coil dimension C, illustrated in FIG. 6, corresponding to the maximum diameter of the coils in the heating element along the first axis. The maximum coil dimension C is preferably at least one-half of the length L, more preferably is at least three-quarters of the length L, and most preferably is substantially the same as the length L.

The heater body 140 may include one or more receptacles 156 to receive a resettable thermal cut off or a permanent thermal cut out. Such devices are conventional. They could be mounted to the outside of the heater body 140, such as in a receptacle 156, to sense the temperature of the brewing liquid indirectly through the temperature of the body 140. Or, they may be disposed inside the body 140 itself, to sense the temperature of the brewing liquid directly.

A conventional resettable thermal cut off has a temperature sensor and a circuit breaker. In the event the temperature sensor exceeds a predetermined value, for example 120° Celcius, the circuit breaker breaks the circuit providing power to the heater 106, thus shutting it down. The thermal cutoff may, of course, be connected to an electronic controller to shut down the entire brewing process at the same time. Once the temperature of the heater 106 drops below the predetermined value, the circuit breaker closes and thus permits the heater 106 to turn back on and/or permits a brewing operation to continue. Such a resettable thermal cut off is useful to ensure the brewing liquid is not too hot to produce satisfactory beverages, or for safety purposes to ensure the brewing liquid does not get hot enough to cause damage to the system.

A conventional permanent thermal cut out (often called a thermal fuse), like a resettable thermal cut off, has a temperature sensor and a circuit breaker. However, the permanent thermal cut out is not resettable. Thus, at some predetermined temperature the circuit breaker permanently prevents power from being supplied to the heater 106. Such a temperature might be, for example, 216° Celsius. A permanent thermal cut out is typically used for safety purposes to ensure the heating system does not get hot enough to cause damage. It may be used as a back-up mechanism for a resettable thermal cut off, where the permanent thermal cut out is set to operate at a higher temperature than the resettable thermal cut off.

The same results can of course be alternatively obtained with a temperature sensor, such as a thermister 500, disposed on or in the heater body 140 in combination with an electronic controller. In this scenario, the electronic controller operates as the circuit breaker. But the electronic controller can additionally use the temperature information received from the thermister 500 in other parts of a brewing operation. For example, the temperature information may be used to determine when the brewing liquid in the heater 106 is hot enough to begin a brewing process, or has reached a boiling point to generate steam.

As discussed above, a relatively large volume capacity heating reservoir can lead to long start-up times for the brewing process. On the other hand, a relatively small volume capacity heating reservoir can lead to difficulties in controlling the temperature of the brewing liquid during a brewing operation. It is believed a heating reservoir volume capacity of between about 50 ml and about 150 ml, or more preferably between about 75 ml and about 125 ml, and most preferably of about 100 ml, is advantageous.

In addition, when trying to optimize a heater for use in a brewing device, the power of the heating element can be considered along with heating reservoir volume capacity. Heating elements are often rated by their maximum wattage output. Typical ratings of heating elements used in brewing devices range from 900 watts to 1400 watts. These power ratings are usually nominal ratings, so that the actual maximum wattage output of a heating element at a given point in time will be within some predetermined range of the stated value. The actual power output of a heating element may be varied in a controlled manner, from 0 watts to the maximum wattage output of the heating element, by varying the voltage applied to the heating element. Using a higher rated heating element operated at full wattage may permit a larger heating reservoir to be used, while still obtaining satisfactory results in start-up time and temperature control.

Thus, it has been found convenient to consider a “watt density” characteristic of a heater. The watt density of a heater is defined as the ratio between the total average power output of the heating element or elements during a brewing operation (expressed in or converted to watts) and the volume capacity of the heating reservoir (expressed in or converted to milliliters). As used herein, “volume capacity” means the volume available within a heating reservoir to store a liquid, excluding space in the reservoir taken up by components such as heating elements, temperature sensors, and the like. Table 1 below illustrates watt density values for a range of average heating element power values and heater reservoir capacities typically seen in coffee brewers:

TABLE 1
Watt Density (watts/ml)

| | | Average Heating Element Power (watts) | | | | | |
|---|---|---|---|---|---|---|---|
| | | 900 | 1000 | 1100 | 1200 | 1300 | 1400 |
| Heater Reservoir | 10 | 90.0 | 100.0 | 110.0 | 120.0 | 130.0 | 140.0 |
| Volume Capacity (ml) | 15 | 60.0 | 66.7 | 73.3 | 80.0 | 86.7 | 93.3 |
| | 20 | 45.0 | 50.0 | 55.0 | 60.0 | 65.0 | 70.0 |
| | 25 | 36.0 | 40.0 | 44.0 | 48.0 | 52.0 | 56.0 |
| | 30 | 30.0 | 33.3 | 36.7 | 40.0 | 43.3 | 46.7 |
| | 35 | 25.7 | 28.6 | 31.4 | 34.3 | 37.1 | 40.0 |
| | 40 | 22.5 | 25.0 | 27.5 | 30.0 | 32.5 | 35.0 |
| | 45 | 20.0 | 22.2 | 24.4 | 26.7 | 28.9 | 31.1 |
| | 50 | 18.0 | 20.0 | 22.0 | 24.0 | 26.0 | 28.0 |
| | 55 | 16.4 | 18.2 | 20.0 | 21.8 | 23.6 | 25.5 |
| | 60 | 15.0 | 16.7 | 18.3 | 20.0 | 21.7 | 23.3 |
| | 65 | 13.8 | 15.4 | 16.9 | 18.5 | 20.0 | 21.5 |
| | 70 | 12.9 | 14.3 | 15.7 | 17.1 | 18.6 | 20.0 |
| | 75 | 12.0 | 13.3 | 14.7 | 16.0 | 17.3 | 18.7 |
| | 80 | 11.3 | 12.5 | 13.8 | 15.0 | 16.3 | 17.5 |
| | 85 | 10.6 | 11.8 | 12.9 | 14.1 | 15.3 | 16.5 |
| | 90 | 10.0 | 11.1 | 12.2 | 13.3 | 14.4 | 15.6 |
| | 95 | 9.5 | 10.5 | 11.6 | 12.6 | 13.7 | 14.7 |
| | 100 | 9.0 | 10.0 | 11.0 | 12.0 | 13.0 | 14.0 |
| | 105 | 8.6 | 9.5 | 10.5 | 11.4 | 12.4 | 13.3 |
| | 110 | 8.2 | 9.1 | 10.0 | 10.9 | 11.8 | 12.7 |
| | 115 | 7.8 | 8.7 | 9.6 | 10.4 | 11.3 | 12.2 |
| | 120 | 7.5 | 8.3 | 9.2 | 10.0 | 10.8 | 11.7 |
| | 125 | 7.2 | 8.0 | 8.8 | 9.6 | 10.4 | 11.2 |
| | 130 | 6.9 | 7.7 | 8.5 | 9.2 | 10.0 | 10.8 |
| | 135 | 6.7 | 7.4 | 8.1 | 8.9 | 9.6 | 10.4 |
| | 140 | 6.4 | 7.1 | 7.9 | 8.6 | 9.3 | 10.0 |
| | 145 | 6.2 | 6.9 | 7.6 | 8.3 | 9.0 | 9.7 |
| | 150 | 6.0 | 6.7 | 7.3 | 8.0 | 8.7 | 9.3 |
| | 155 | 5.8 | 6.5 | 7.1 | 7.7 | 8.4 | 9.0 |
| | 160 | 5.6 | 6.3 | 6.9 | 7.5 | 8.1 | 8.8 |
| | 165 | 5.5 | 6.1 | 6.7 | 7.3 | 7.9 | 8.5 |
| | 170 | 5.3 | 5.9 | 6.5 | 7.1 | 7.6 | 8.2 |
| | 175 | 5.1 | 5.7 | 6.3 | 6.9 | 7.4 | 8.0 |
| | 180 | 5.0 | 5.6 | 6.1 | 6.7 | 7.2 | 7.8 |
| | 185 | 4.9 | 5.4 | 5.9 | 6.5 | 7.0 | 7.6 |
| | 190 | 4.7 | 5.3 | 5.8 | 6.3 | 6.8 | 7.4 |
| | 195 | 4.6 | 5.1 | 5.6 | 6.2 | 6.7 | 7.2 |
| | 200 | 4.5 | 5.0 | 5.5 | 6.0 | 6.5 | 7.0 |
| | 250 | 3.6 | 4.0 | 4.4 | 4.8 | 5.2 | 5.6 |
| | 300 | 3.0 | 3.3 | 3.7 | 4.0 | 4.3 | 4.7 |
| | 350 | 2.6 | 2.9 | 3.1 | 3.4 | 3.7 | 4.0 |
| | 400 | 2.3 | 2.5 | 2.8 | 3.0 | 3.3 | 3.5 |
| | 450 | 2.0 | 2.2 | 2.4 | 2.7 | 2.9 | 3.1 |
| | 500 | 1.8 | 2.0 | 2.2 | 2.4 | 2.6 | 2.8 |
| | 550 | 1.6 | 1.8 | 2.0 | 2.2 | 2.4 | 2.5 |

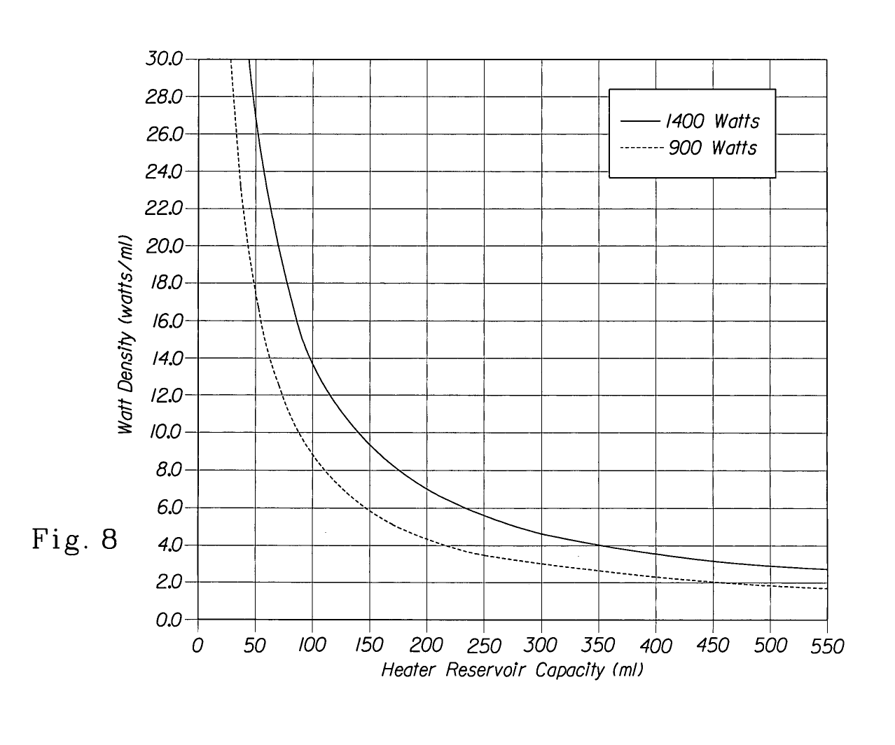

FIG. 8 illustrates a plot to show how the watt density varies with heater reservoir volume capacity for a given average heating element power, for example 900 or 1400 watts. As a representative example, FIG. 8 shows that for a heating element with an average power of 1400 watts during a brewing operation used in conjunction with a heater reservoir having a 100 ml volume capacity, the watt density is 14 watts/ml.

It is preferred to have a heater with a watt density of no less than about 6 watts/ml, more preferred to have a heater with a watt density of no less than about 9 watts/ml, and most preferred to have a heater with a watt density of no less than about 12 watts/ml. It is preferred to have a heater with a watt density of no more than about 30 watts/ml, more preferred to have a heater with a watt density of no more than about 22 watts/ml, and most preferred to have a heater with a watt density of no more than about 16 watts/ml. In addition, a specific watt density of about 14 watts/ml has proven to be a good design. Various combinations of these preferred values may be made to generate different ranges of advantageous values for the watt density.

Alternatively or additionally in consideration of a watt density, it has also been found convenient to consider a residence-to-lag time ratio. The residence time numerator of this ratio is the average residence time of the brewing liquid within the heating reservoir. Assuming a hydrostatically full system, where there are no significant air pockets in the brewing liquid, the residence time numerator may be approximated by dividing the average flow rate of the brewing liquid into the volume capacity of the heating reservoir. The lag time denominator of this ratio is the amount of time it takes for the temperature sensor, upon the brewing liquid changing from an old temperature to a new temperature, to reflect 97% of the expected change in temperature.

The lag time denominator may be empirically determined for a given temperature sensor. For example, a first pool of liquid may be kept at a first known temperature such as 25° Celsius, and a second pool of liquid may be kept at a second known temperature such as 100° Celsius. A temperature sensor to be tested is placed in the first pool until it reflects the first temperature. The temperature sensor is then placed in the second pool The expected change in temperature is calculated from the difference between the first and second temperatures, which in this example is 75° Celsius. Ninety-seven percent of that expected change is about 73° Celsius. Thus the lag time denominator is the time it takes the temperature sensor to reach 98° Celsius after it is placed in the second pool (the starting temperature of 25° plus a 73° increase). Use of two pools of liquid in this manner is only one method of measuring the lag time denominator of the residence-to-lag ratio; others will be readily apparent to one of ordinary skill in the art.

As an example, if the average flow rate of the brewing liquid is 5 ml per second, and the volume capacity of the heating reservoir is 100 ml, then the average residence time of brewing liquid in the reservoir is 20 seconds. If the lag time of the temperature sensor is then 5 seconds, the residence-to-lag time ratio is 4. Physically, this means the brewing liquid spends about four times as long in the heating reservoir getting warmed up than it takes for the temperature sensor to measure the temperature of the brewing liquid.

If the residence-to-lag time ratio is very small, the brewing liquid is flowing too fast for the temperature sensor to keep up with brewing liquid temperature changes. This typically occurs in small volume capacity heating reservoirs. If the residence-to-lag time ratio is very large, the brewing liquid temperature changes slowly enough for the temperature sensor to keep up. However, this can concomitantly result in long start-up times before brewing can begin. This latter situation typically occurs in large volume capacity heating reservoirs.

Therefore, it is preferred to have a residence-to-lag time ratio of no less than about 2, more preferred to have a residence-to-lag time ratio of no less than about 3, and most preferred to have a residence-to-lag time ratio of no less than about 4. It is preferred to have a residence-to-lag time ratio of no more than about 10, more preferred to have a residence-to-lag time ratio of no more than about 8, and most preferred to have a residence-to-lag time ratio of no more than about 6. A residence-to-lag time ratio of no more than about 4 has been found to be advantageous. Various combinations of these preferred values may be made to generate ranges of advantageous values for the residence-to-lag time ratio.

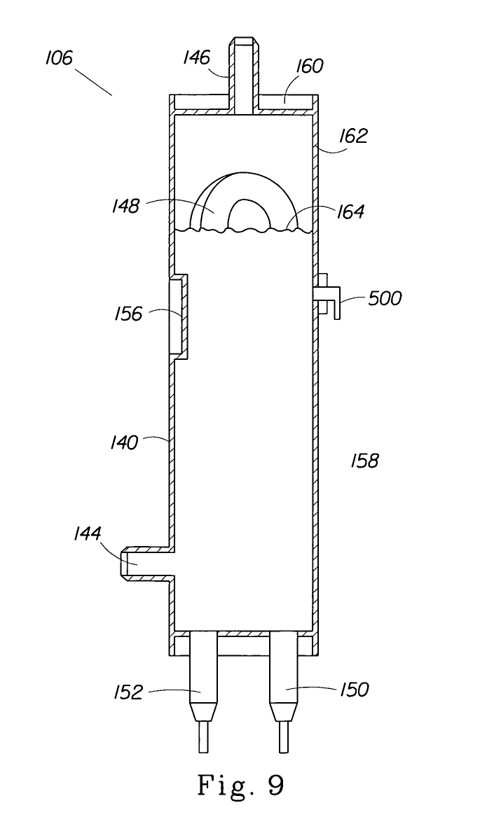

FIG. 9 shows a supply of brewing liquid 158 held within the heating reservoir 142 of the heater body 140. In this particular embodiment, the outlet 146 is disposed in the top end wall 160 of the heater body 140. Although not illustrated, the outlet 146 may alternatively be disposed in the sidewall 162 of the heater body 140, near the top end wall 160. In such configurations, the outlet 146 will be advantageously disposed above the surface level 164 of the brewing liquid 158 during at least some portion of a steam purging process, as discussed further below.

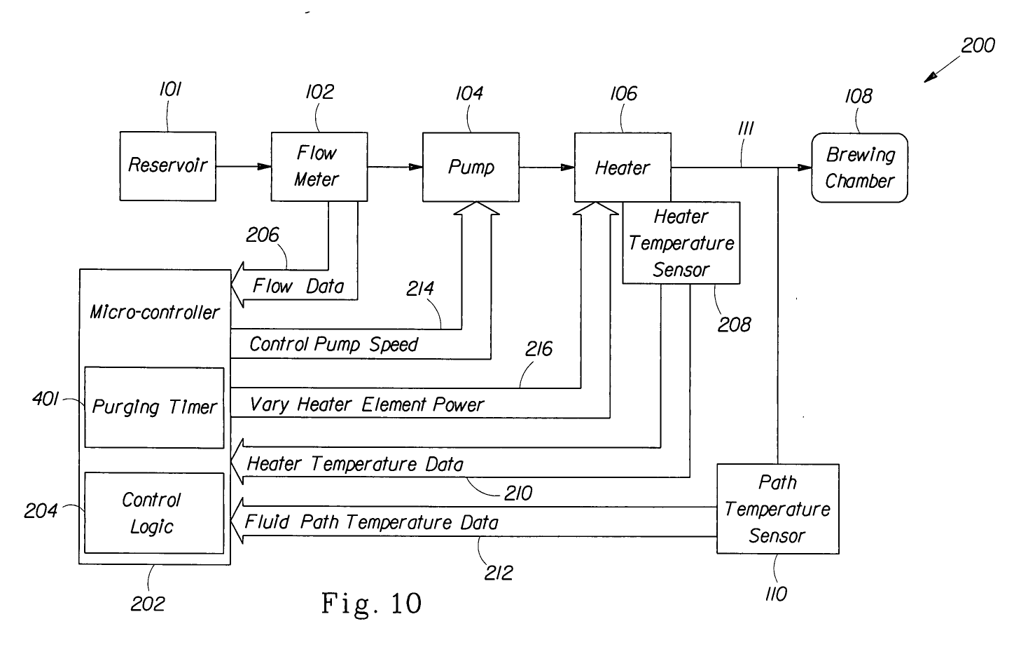

FIGS. 10-12 show how a temperature control logic 300 may be used during a brewing operation in a brewing device 100. In the flowcharts of these Figures, the rectangular elements denote processing blocks and represent software instructions or groups of instructions. The quadrilateral elements denote data input/output processing blocks and represent software instructions or groups of instructions directed to the input or reading of data or the output or sending of data. The flow diagrams shown and described herein do not depict syntax of any particular programming language. Rather, the flow diagrams illustrate the functional information one skilled in the art may use to fabricate circuits or to generate software to perform the processing of the system. It should be noted that many routine program elements, such as initialization of loops and variables and the use of temporary variables are not shown. Prior to discussing the temperature control logic 300, a review of the definitions of some exemplary terms used throughout the disclosure is appropriate. Both singular and plural forms of all terms fall within each meaning.

“Logic,” as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), or other programmed logic device. Logic may also be fully embodied as software.

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

Turning now to the diagram of FIG. 10, one embodiment of a brewing system 200 incorporating a temperature control logic 204 is shown. The system has a controller 202 with control logic 204, in addition to the components from FIG. 1 as shown. The controller 202 is preferably processor-based and can include various input/output circuitry including analog-to-digital (A/D) inputs and digital-to-analog (D/A) outputs. The controller 202 receives data from several sources. The flow meter 102 provides flow data 206 indicative of the flow rate of brewing liquid from the storage reservoir 101 to the pump 104. A heater temperature sensor 208 provides temperature data 210 indicative of the temperature of brewing liquid stored in or flowing through the heater 106. The fluid flow path temperature sensor 110 provides temperature data 212 indicative of the temperature of brewing liquid in the fluid flow path 111 between the heater 106 and the brewing chamber 108. As described further below, the controller 202 uses this data to control 214 the brewing liquid flow rate and, if necessary, vary 216 the power of the heating element 148 in the heater 106.

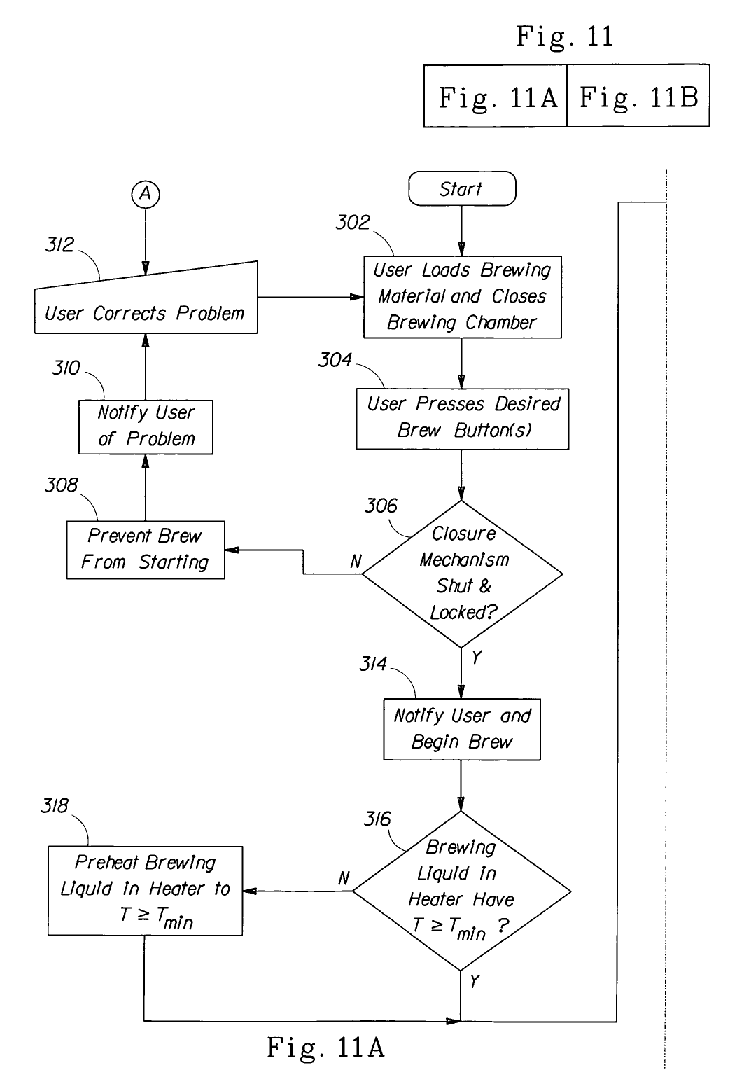

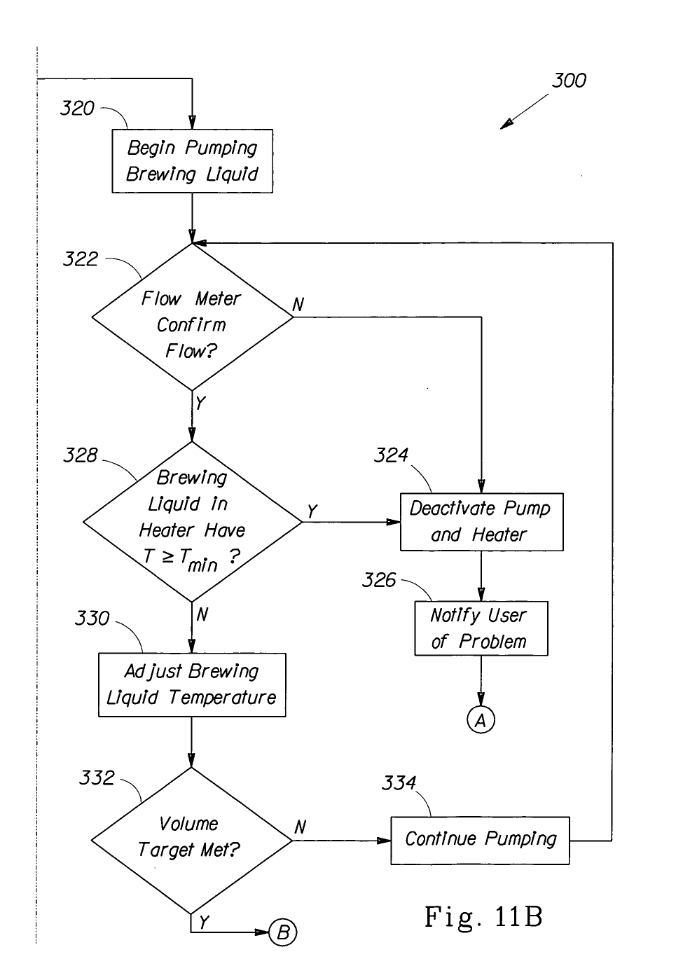

A representative temperature control logic 300 for a brewing operation is shown in FIGS. 11A and 11B. As a first step 302, the user begins the brewing operation by loading an amount of brewing material into the brewing chamber of a brewing unit 14 and closing the closure mechanism 18. The user then presses the appropriate button(s) 304 to instruct the controller 202 as to what kind of brewing operation is desired. This information might include the amount of brewed beverage desired (7 ounces, 9 ounces, 14 ounces, etc.) and what kind of material is being brewed (plain coffee, coffee with cream, etc.). From this data, the controller 202 determines various control parameters such as the appropriate amount of brewing liquid to supply to the brewing chamber, and a target temperature for the brewing liquid exiting the heater 106. The controller 202 may also rely on the heater temperature data 210 to set these control parameters—for example, if the brewing liquid in the heater 106 is relatively cold because a brewing operation has not been recently performed, the target temperature may be set higher.

The controller 202 then verifies 306 whether the closure mechanism 18 is shut and locked. The controller 202 may do this by, for example, determining whether a limit switch disposed proximate to the closure mechanism 18 has been tripped. If it appears the closure mechanism 18 is not closed, the controller 202 prevents a brew from starting 308 and indicates to the user a problem has occurred 310. Such a problem signal could include a stop light, a buzzer, or a similar signal. The user then corrects the problem 312 and presses the desired brew buttons 304 to start the process 300 over again.

Once the closure mechanism 18 is closed, the controller 202 begins the brew process and indicates to the user the process has begun 314. A voltage is applied to the heating element 148 in the heater 106 to start heating up the brewing liquid left over in the heater 106 from the last brew. The power of the heater is initially set to its maximum rated value. From the heater temperature data 210 the controller 202 determines 316 whether the brewing liquid in the heater 106 has a sufficient minimum temperature Tₘᵢₙ to start a brewing process. Tₘᵢₙ is set at the minimum temperature for effective brewing of a good beverage. If the temperature of the brewing liquid in the heater 106 is less than Tₘᵢₙ, the controller waits 318 until Tₘᵢₙ is reached as a result of the liquid being heated by the heating element 148.

Once the brewing liquid in the heater 106 reaches Tₘᵢₙ, the controller 202 starts 320 the pump 104 to begin pumping brewing liquid to the brewing chamber 108. The controller 202 checks 322 the flow meter data 206 to make sure the flow is greater than zero. If the controller 202 determines there is no flow, the controller 202 deactivates 324 the pump 104 and heater 106, and notifies 326 the user a problem has occurred. The user corrects the problem 312, such as by adding brewing liquid to the brewing reservoir 101, and presses the desired brew buttons 304 to start the process 300 over again.

If the controller 202 determines the flow is greater than zero at step 322, it next checks 328 the temperature of the brewing liquid in the heater 210 to determine whether it exceeds some maximum temperature Tₘₐₓ. Tₘₐₓ might be set, for example, as a maximum temperature of brewing liquid which leads to a satisfactory brewed beverage. If the maximum temperature is exceeded, the controller 202 deactivates 324 the pump 104 and heater 106, and notifies 326 the user a problem has occurred. The user corrects the problem 312, such as by adding brewing liquid to the storage reservoir 101, and presses the desired brew buttons 304 to start the process 300 over again.

If the check 328 indicates the temperature of the brewing liquid in the heater 310 does not exceed the maximum temperature Tₘₐₓ, the controller checks 330 the data 212 for temperature of the brewing liquid in the fluid flow path 111. If that temperature 212 differs from the target temperature for the type of brew selected by the user 304, the controller 202 follows a primary/secondary control process to vary the temperature.

As a primary control, the controller 202 adjusts the flow rate of the brewing liquid by adjusting the brewing liquid flow rate, thereby controlling the temperature of the brewing liquid in line 111. It may do this by applying, for example, a proportional control, a proportional derivative control, a proportional integral control, a proportional integral derivative control, or similar control loop. If the brewing liquid temperature 212 is too low, the speed of pump 104 is decreased, so that brewing liquid spends more time in heater 106 and thus reaches a higher temperature in the line 111. If the brewing liquid temperature 212 is too high, the speed of pump 104 is increased, so that brewing liquid spends less time in heater 106 and thus does not reach as high a temperature in the line 111. Pump adjustments may be made in a step-wise fashion as the process 300 continually loops back through the checking step 330 until the volume target is met 332. If the error between target temperature and measured temperature is relatively large, then the pump speed may be changed by a relatively large amount. If the error between target temperature and measured temperature is relatively small, then the pump speed may be changed by a relatively small amount. Mechanisms other than pump speed can be used to vary the brewing liquid flow rate, such as for example a variable size orifice disposed downstream of the pump.

A secondary control is provided, relying on the heating element 148 in the event the primary flow rate control is not sufficient. More particularly, if the flow rate has reached the maximum pumping capability of the particular pump being utilized, and the brewing liquid temperature still needs to be decreased, the controller 202 reduces the power of the heating element 148 in the heater 106. Similarly, if the flow rate has reached the minimum pumping capability of the particular pump being utilized, and the brewing liquid temperature still needs to be increased, the controller 202 increases the power of the heating element 148 in the heater 106. Varying the flow rate is used as the primary control because the flow rate can be controlled in a much more precise and responsive manner than the power of the heating element 148. Thus, in the usual operation of the temperature control process 300, the power of the heating element 148 is usually not changed much, if at all. Rather, it usually stays at a relatively high level, with changes in the brewing liquid flow rate controlling the brewing liquid temperature. But of course, heating element power may alternatively be used as the sole temperature control, or the primary temperature control in conjunction with other controls.

After adjusting the temperature of brewing liquid 330, the controller 202 checks 332 the volume of brewing liquid which has been pumped during the brewing process. The controller 202 can determine the amount of brewing liquid which has been pumped by tracking the flow meter data 206 throughout the process 300, and integrating the flow over time. For example, if a pulse meter is used, the controller can count the number of pulses and determine volume from the known volume of brewing liquid pumped per pulse. If the target volume for the brew selected by the user has not been met, the pumping continues 334 and the process 300 loops back to the check flow meter step 322. If the target volume has been met, the controller 202 either shuts down the system or, if desired, begins a purging process.

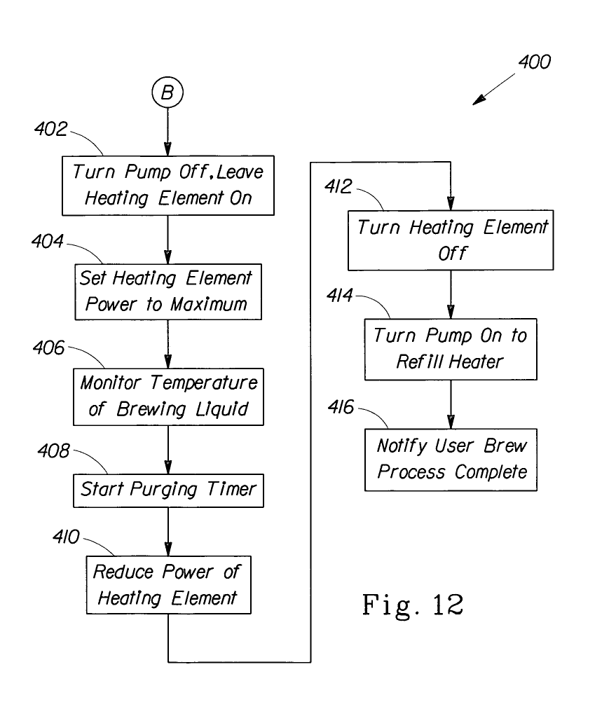

One example of a purging process is shown in FIG. 12. At the beginning of this purging process 400, the pump 104 is turned off but the heater 106 is left on 402. The heating element power is set at its maximum power rating 404, if it is not already at that level. The temperature of the brewing liquid in the heater 210 is monitored 406 to determine when it reaches the boiling point for the brewing liquid, which is 100° Celsius for water. This causes steam to rise up from the brewing liquid which is lying dormant in the heater 106 as a result of the pump 104 being turned off. The steam permeates through the fluid flow path 111 to reach the brewing chamber in the brewing unit 14. There the steam dries the now-used brewing material to an extent that it is easily removed by the user without excessive sticking, dripping or other mess. In the event a combined coffee/cream pod was used, the steam additionally operates to force excess cream or other liquid out of the pod.

The heater shown in FIG. 9 and described above is particularly useful in connection with a steam purging process. Steam rising from the surface 164 will tend to carry at least some excess, unvaporized brewing liquid along with it. With the outlet 146 of the heater 106 disposed above the surface level 164 of the brewing liquid, however, large amounts of excess brewing liquid are unlikely to reach the outlet 146. That is because gravity tends to cause most of the brewing liquid carried with the steam to fall back into the pool 158 before the steam reaches the outlet 146.

At the beginning of the purging process, the brewing liquid surface level 164 may be disposed at or near the level of the outlet 146. In that event, for some amount of time, relatively large amounts of excess unvaporized brewing liquid may remain trapped in the flow of steam as it exits the heating reservoir 142. However, as that trapped liquid is carried away and other liquid is converted to steam, the surface level 164 falls. At some point after steam begins generating, the surface level 164 reaches a low enough level in the heating reservoir 142 that most of the liquid carried in the steam falls back into the pool 158 before the steam reaches the outlet 146. This makes for improved reproducibility from brew to brew of liquid volume output during the purging process.

Once the brewing liquid boiling point temperature is reached, a purging timer 401 is started 408. The purging timer 401 may, for example, be incorporated as part of the controller 202 as shown in FIG. 10. Steam is then generated for a pre-determined amount of time, as measured by the purging timer 401. The steam time is set at a pre-determined amount which is effective to purge the system by sufficiently reducing the amount of liquid left behind, including liquid left in the brewing chamber. The purged liquid is forced through the brewing chamber and out the spout 20 of the brewing unit 14. Thus, the purging process 400 will cause some amount of brewed beverage to be dispensed after a brewing operation 300 is complete. However, the amount of brewed beverage generated during the purging process 400 is highly repeatable from brew to brew, because steam is generated for a set amount of time and in a controlled fashion. Once this repeatable amount of dispensed beverage is empirically determined for a particular brewer device, the target volume value used in step 332 of the brewing operation 300 may be reduced so that the overall amount of brewed beverage produced as a result of both processes 300, 400 is highly repeatable from brew to brew.

For generating one or two cups of black coffee, it is advantageous to have a steam time of no less than about 5 seconds, or no less than about 7 seconds, or no less than about 9 seconds. For generating one or two cups of a combination of coffee and cream brewed together in the brewing chamber, it is advantageous to have a steam time of no less than about 10 seconds, or no less than about 12 seconds, or no less than about 14 seconds.

For generating one or two cups of black coffee, it is advantageous to have a steam time of no more than about 15 seconds, or no more than about 13 seconds, or no more than about 11 seconds. For generating one or two cups of a combination of coffee and cream brewed together in the brewing chamber, it is advantageous to have a steam time of no more than about 20 seconds, or no more than about 18 seconds, or no more than about 16 seconds.

Instead of starting the purging timer 401 (FIG. 10) when the brewing liquid in the heater 106 reaches its boiling point 408, the timer 401 may alternatively be started earlier in the process. For example, it may be started when the pump 104 is shut off 402, or the heating element power is set to maximum 404.

Once the brewing liquid boiling point temperature is reached, it may be advantageous to reduce the power of the heating element 410 for the remainder of the steam generation process. For example, the heating element power may be reduced by as much as 50 percent of the power needed to heat the brewing liquid during the brewing operation. This helps prevent generating too much steam, which can result in splashing of the hot brewed beverage as it is dispensed into a cup for consumption, as well as over-pressurizing the system.

Once the set time period has elapsed, or the purging process otherwise ended, the heater 106 is turned off 412. As discussed above, a vacuum vent valve 112 may be disposed within the fluid flow path 111 to relieve a vacuum occurring in the fluid flow path 111 as a result of steam condensation forming in the path 111 after the heater 106 is turned off. It may also be advantageous to turn the pump 104 on 414 to refill the heater 206 at this point in the process 400. This would replace brewing liquid lost during the steam generation process, and ensure a sufficient amount of brewing liquid is in the heater 106 when the brewing process begins again. The user is notified that the brew process is complete 416. It may be advantageous to provide a delay between the time the heater 106 is turned off 412 and the time of user notification 416. Such a delay would permit the steam remaining in the system to further dry the brewing material and filter paper in the brewing chamber, and to allow the system to depressurize.

While the present invention has been illustrated by the description of embodiments thereof, and while the embodiments have been described in considerable detail, it is not intended for this to restrict or in any way limit the scope of the claimed invention to such detail. Additional advantages and modifications will readily appear to those skilled in the art. For example, although the steps of the temperature control process 300 and the purging process 200 have been described in some detail and in a particular order, of course different or additional steps may be used, or the described steps performed in a different order. Therefore, the invention in its broader aspects is not limited to the specific details and illustrative examples shown and described. Accordingly, departures may be made from such details without departing from the spirit or scope of the general inventive concept.

We claim:

1. A heater for use in a brewer device, comprising:
i. a body forming a heating reservoir and comprising an inlet for a brewing liquid to enter the heating reservoir and an outlet for the brewing liquid to exit the heating reservoir, wherein the heating reservoir has a volume capacity for storing brewing liquid;
ii. one or more heating elements disposed in or near the body for heating the brewing liquid disposed in the heating reservoir, and a source of voltage to control a power of the one or more heating elements;
iii. wherein the volume capacity of the heating reservoir and the power of the one or more heating elements are selected so as to have a watt density of no less than about 6 watts per milliliter and no more than about 30 watts per milliliter.

2. A heater as in claim 1, wherein the volume capacity of the heating reservoir and the power of the one or more heating elements are selected so as to have a watt density of no less than about 9 watts per milliliter and no more than about 22 watts per milliliter.

3. A heater as in claim 2, wherein the volume capacity of the heating reservoir and the power of the one or more heating elements are selected so as to have a watt density of no less than about 12 watts per milliliter and no more than about 16 watts per milliliter.

4. A heater as in claim 3, wherein the volume capacity of the heating reservoir and the power of the one or more heating elements are selected so as to have a watt density of about 14 watts per milliliter.

5. A heater as in claim 1, wherein at least one heating element is disposed in the body.

6. A heater as in claim 1, further comprising a temperature sensor disposed in the heating reservoir and in electronic communication with a controller.

7. A heater as in claim 6, further comprising a resettable thermal cut off or a permanent thermal cut out disposed on the exterior of the body for controlling the power of the heating element.

8. A heater as in claim 1, wherein the body has a first end disposed opposite to a second end, and the inlet is disposed at or near the first end and the outlet is disposed at or near the second end.

9. A heater as in claim 1, wherein the heating reservoir has a capacity of between about 50 milliliters and about 150 milliliters of brewing liquid.

10. A heater as in claim 9, wherein the heating reservoir has a capacity of between about 75 milliliters and about 125 milliliters of brewing liquid.

11. A heater as in claim 10, wherein the heating reservoir has a capacity of about 100 milliliters of brewing liquid.

12. A heater as in claim 1, wherein the heating element has a power rating of about 1400 watts.

13. A brewing device, comprising:
i. a pump having a pump inlet and a pump outlet, the pump inlet being fluidically connected to a reservoir of brewing liquid;
ii. a heater comprising a heater body and one or more heating elements, the heater body forming a heating reservoir and having a heater inlet and a heater outlet, the heater inlet being fluidically connected to the pump outlet, and the one or more heating elements being disposed in or near the heating reservoir for heating a brewing liquid in the heating reservoir, wherein the volume capacity of the heating reservoir and the power of the one or more heating elements are selected so as to have a watt density of no less than about 6 watts per milliliter and no more than about 30 watts per milliliter;
iii. a brewing chamber for holding a supply of coffee to be brewed by the brewing liquid, the brewing chamber having a chamber inlet and a chamber outlet, the chamber inlet being fluidically connected to the heater outlet by a liquid flow path; and
iv. a dispensing outlet being fluidically connected to the chamber outlet.

14. A brewing device as in claim 13, wherein the volume capacity of the heating reservoir and the power of the one or more heating elements are selected so as to have a watt density of no less than about 9 watts per milliliter and no more than about 22 watts per milliliter.

15. A brewing device as in claim 14, wherein the volume capacity of the heating reservoir and the power of the one or more heating elements are selected so as to have a watt density of no less than about 12 watts per milliliter and no more than about 16 watts per milliliter.

16. A brewing device as in claim 15, wherein the volume capacity of the heating reservoir and the power of the one or more heating elements are selected so as to have a watt density of about 14 watts per milliliter.

17. A brewing device as in claim 13, wherein at least one heating element is disposed within the body.

18. A brewing device as in claim 13, further comprising a temperature sensor disposed in the liquid flow path.

19. A brewing device as in claim 18, further comprising a pressure relief valve disposed in the liquid flow path.

20. A brewing device, comprising:
i. a pump having a pump inlet and a pump outlet, the pump inlet being fluidically connected to a reservoir of brewing liquid to pump the brewing liquid at a flow rate;
ii. a heater comprising a heater body and a heating element, the heater body forming a heating reservoir and having a heater inlet and a heater outlet, the heater inlet being fluidically connected to the pump outlet, the heating element being disposed in or near the heating reservoir for heating a brewing liquid in the heating reservoir, and the heating reservoir having a volume capacity;
iii. a temperature sensor for measuring the temperature of the brewing liquid and having a measurement lag time, wherein the flow rate, the heating reservoir volume capacity, and the temperature sensor measurement lag time are chosen so that a residence-to-lag time ratio is no less than about 2 and no more than about 10;
iv. a brewing chamber for holding a supply of coffee to be brewed by the brewing liquid, the brewing chamber having a chamber inlet and a chamber outlet, the chamber inlet being fluidically connected to the heater outlet by a liquid flow path; and
v. a dispensing outlet being fluidically connected to the chamber outlet.

21. A brewing device as in claim 20, wherein the flow rate, the heating reservoir volume capacity, and the temperature sensor measurement lag time are chosen so that a residence-to-lag time ratio is no less than about 3 and no more than about 8.

22. A brewing device as in claim 21, wherein the flow rate, the heating reservoir volume capacity, and the temperature sensor measurement lag time are chosen so that a residence-to-lag time ratio is no less than about 4 and no more than about 6.

23. A method of brewing and steam purging a brewing material in a brewing device, comprising:
i. placing the brewing material in a brewing chamber of the brewing device;
ii. operating a heating element disposed in or near a heating reservoir to heat a supply of brewing liquid, which includes at least some amount of water,
iii. operating a pump to pressurize the brewing liquid, and using the pressurization to pass the heated supply of brewing liquid through the brewing material to perform a brewing operation;
iv. after the brewing operation is complete, deactivating the pump and setting a power of the heating element so that a portion of water in the heater becomes steam; and
v. generating the steam for a pre-determined amount of steam time, and passing the steam through the brewing material in the brewing chamber.

24. A method as in claim 23, wherein the brewing material comprises coffee, and the steam time is no less than about 5 seconds and no more than about 15 seconds for brewing black coffee.

25. A method as in claim 24, wherein the steam time is no less than about 7 seconds and no more than about 13 seconds for brewing black coffee.

26. A method as in claim 25, wherein the steam time is no less than about 9 seconds and no more than about 11 seconds for brewing black coffee.

27. A method as in claim 23, wherein the brewing material comprises coffee and milk, and the steam time is no less than about 10 seconds and no more than about 20 seconds for brewing a combination of coffee and milk together in the brewing chamber.

28. A method as in claim 27, wherein the steam time is no less than about 12 seconds and no more than about 18 seconds for brewing a combination of coffee and milk together in the brewing chamber.

29. A method as in claim 28, wherein the steam time is no less than about 14 seconds and no more than about 16 seconds for brewing a combination of coffee and milk together in the brewing chamber.

30. A method as in claim 23, wherein the heater has an outlet through which the steam exits from the heating reservoir to reach the brewing material, and the brewing liquid in the heating reservoir forms a pool with a surface level, such that for at least a portion of the pre-determined amount of steam time the surface level is at a level within the heating reservoir such that most of the liquid carried in the steam falls back into the pool before the steam reaches the outlet.

31. A method of brewing a brewing material in a brewing device, comprising:
i. placing the brewing material in a brewing chamber of the coffee brewing device;
ii. operating a heating element disposed in or near a heating reservoir to heat a supply of brewing liquid;
iii. operating a pump to pressurize the brewing liquid, and using the pressurization to pass the heated supply of brewing liquid through the brewing material to perform a brewing operation; and
iv. adjusting a flow rate of the brewing liquid during the brewing operation to control a temperature of the brewing liquid.

32. A brewing method as in claim 31, wherein the heating element has a power output, further comprising adjusting the power output of the heating element as a secondary control of the temperature of the brewing liquid.

33. A brewing method as in claim 31, further comprising a flow meter to measure the flow rate of the brewing liquid.

34. A method as in claim 31, further comprising a temperature sensor disposed in or near the heating reservoir for measuring a temperature of the brewing liquid.

35. A brewing method as in claim 31, further comprising a microcontroller which monitors a temperature of the brewing liquid in the brewing device through a temperature sensor, and controls the temperature of the brewing liquid in the brewing device by adjusting the flow rate of the brewing liquid.
